(19) United States
(12) Patent Application Publication
(10) Pub. No.: US 2024/0100805 A1
(43) Pub. Date: Mar. 28, 2024

(54) TRILAMINATE PROCESS TO PRODUCE A VARIABLE DENSITY POLYMER MULTILAMINATE, USING A FORMULATED POLYMERIC ADHESIVE

(71) Applicant: Emilio Allande BERRUETA, Pais (MX)

(72) Inventor: Emilio Allande BERRUETA, Pais (MX)

(21) Appl. No.: 18/243,461

(22) Filed: Sep. 7, 2023

(30) Foreign Application Priority Data
Sep. 23, 2022 (MX) MX/A/2022/011836

(51) Int. Cl. B32B 5/02; B32B 5/18; B32B 5/24; B32B 7/12; B32B 27/12; B32B 27/32; B32B 37/04

(52) U.S. Cl. CPC B32B 5/022; B32B 5/18; B32B 5/245; B32B 7/12; B32B 27/12; B32B 27/32; B32B 37/04; B32B 2250/05; B32B 2305/70; B32B 2307/518; B32B 2323/043

(57) ABSTRACT

A process for making a multilaminate containing polymers of variable density is provided. The method involves making a bilayer roll 1 by laminating a layer containing a formulated polymer adhesive (component (2)) and a layer containing a non-woven fabric containing at least 50% recycled polypropylene resin (component (3)); making a trilayer roll 2 containing three laminated layers by laminating a layer containing a bioriented polypropylene (component (1)) and a bilayer from roll 1; making a trilayer roll 3 containing three laminated layers by laminating a layer containing a polyethylene foam having uniformly distributed air bubbles (component (4)) and a bilayer from roll 1; and making a multilayer roll 4 and a multilayer roll 5, each containing at least two selected from a bilayer from roll 1, a trilayer from roll 2, and a trilayer from roll 3. The multilaminate may contain five or more layers.

### CROSS-REFERENCE TO RELATED APPLICATION

This application claims priority under 35 U.S.C. § 119(b) to Mexican Application No. MX/A/2022/011836, filed Sep. 23, 2022, the disclosure of which is incorporated herein by reference in its entirety.

### BACKGROUND

The present invention relates to a trilaminate process to make a multilaminate of variable density polymers, by means of a formulated polymeric adhesive. The state of the art is cited in patent applications, as well as information relevant to the novelty and inventive activity and thus a better understanding of the invention.

U.S. Pat. No. 6,475,578 relates to a flexible packaging airtight and removable flexible peelable seal system and multilayer films and packaging structures made from them that incorporate a peelable seal that works through two peel mechanisms that depend on temperature. Multilayer films, and the packages in which they are used, have multiple layers, including a fifth layer comprising high-density polyethylene, a fourth layer comprising high density polyethylene, a third layer comprising high density polyethylene; a second layer comprising high density polyethylene and polybutylene, and a first layer comprising ethylene vinyl acetate copolymer, polyethylene polybutylene plastomer.

US2001/046540 describes a bag or container for food made of a peelable film and procedure for its production, by sealing and cutting the synthetic material by means of an automatic horizontal direction packaging machine. A hermetic bag or container of synthetic material is obtained for the preservation of food products. The container is made up of a single peelable type film made up of a layer of oriented polyamide coupled to a layer of peelable coextruded polyethylene, said film being folded once on the side of the polyethylene layer to form the inner part of said packaging.

US2003157355 describes a multilayer heat shrinkable film, a multilayer heat shrinkable film that includes a heat-sealable thermoplastic inner layer, an abuse layer of a blend of thermoplastic polymers having a higher average melting point than said inner layer, and an optically clear thermoplastic outer layer adjacent to said abuse layer, wherein said outer layer has a lower Vicat softening point than said abuse layer. A film according to the invention has high hot water seal resistance, high burn resistance and superior optical properties without the need for irradiation.

US2006/110616 relates to polyethylene blends with improved Vicat softening point and a method of selecting polyethylene components for a polyethylene composition with improved Vicat softening point comprising blending at least a first polyethylene with a first density and a second polyethylene with a second density to form the polyethylene composition, where the first density is greater than the second density, and determining a first Vicat softening point (V1) of the measured composition, and calculating a second Vicat softening point (V2) of the composition using the formula V2=[Sigmaln{W1(Vicat softening point of the first polyethylene)+W2(Vicat softening point of the second polyethylene) . . . Wn(Vicat softening point of the nth polyethylene)}], where W1 is the weight fraction of the first polyethylene, W2 is the weight fraction of the second polyethylene and Wn is the weight fraction of the nth polyethylene, n ranges from 2 to 10 and W1+W2 . . . +Wn=1.0; comparing V1 and V2; selecting the polyethylene components such that V1 is less than V2 for the polyethylene composition. The patent packaging and thermal protection of the product of this invention refers to a product made up of a layer of plastic bubble associated with an aluminum film or 5 metallized BOPP (bioriented polypropylene), used for thermal packaging or protection of objects in order to provide greater resistance, greater thermal insulation capacity, maintaining its flexibility, with a more efficient and profitable product.

The bioriented polypropylene film patent MY128146A describes bioriented polypropylene (bopp) films in which at least one layer constitutes a propylene polymer with a content of at least 0.8% by weight of ethylene and optionally one or more c4-c10 α-olefins, 5 or a propylene polymer composition containing at least 0.8% by weight of one or more comonomers selected from ethylene and c4-c10 α-olefins, and having the following characteristics: 1) a melting point of 155° C. or higher; 2) a fraction content soluble in xylene at room temperature of less than 3% by weight, and a value of the ratio of the polymer fraction collected in the temperature range from 25° C. to 95° C. (by tref) to said xylene soluble fraction greater than 8.

GB2501863A relates to a thermal insulating material which comprises a ‘crown-to-crown’, double-layer, air-retaining, air-sealed, heat-bonded, circular bubble closed-cell structure. This structure (1,2) is preferably made of coextruded bubble plastic film comprising [linear low-density polyethylene (LLDPE) or low-density polyethylene (LDPE)], high-density polyethylene (HDPE) and nylon (polyamide (PA)) laminated and interposed between two outer reflective layers (3, 4). Both outer reflective layers (3, 4) comprise vacuum applied metallised coextruded bioriented polypropylene (BOPP). The double layer barrier sealed circular bubble closed cell structure comprises a plurality of cells (5) containing air.

### OBJECT OF THE INVENTION

The object of the present invention is to provide a trilaminate process for producing a variable density polymer multilaminate by means of a formulated polymeric adhesive, which can be used to manufacture bags, packaging, raincoats, medical coveralls, laboratory coveralls, waterproof bags, bags for personal use, backpacks, thermal bags, bags resistant to effort by weight, envelopes for postal shipments or waterproof and resistant parcels, envelopes for fragile items, tablet holders, computer holders, coolers, lunchboxes, and sandwich makers. The manufacturing versatility of the aforementioned products are due to the properties generated by the bilaminate process followed by a trilaminate by means of an adhesive formulated and laminated between the bilaminate and the trilaminate, combined with an ultrasound process as a polymer chemical reaction catalyst. These in turn can be combined to form a multilaminate with (n+1)^{x} layers, where n is greater than or equal to three and one is the increase to the x number of layers depending on the function desired in the final product, changing its thermal characteristics and resistance to cutting effort, elongation, flexibility and permeability.

### BRIEF SUMMARY OF THE INVENTION

The difference between the aforementioned patents and the present invention lies in the process of how low or ultra-low density homopolymer material is bilaminated with copolymers of ultra-low density and medium and high density, with a first adhesive layer that is described in detail as component (2) in the present invention, and this combined bilayer, is combined with another trilayer that in turn also comprises component (2) as a constant and is combined with three other components (1), (3) and (4) with its different combinations and permutations, to achieve a multilaminate product with numbers of layers to the n where n is equal to an infinite number of layers in millimeters of thickness

### BRIEF DESCRIPTION OF THE FIGURES

In the present invention, the figures are shown in processes in order to give a better description of the present invention, being demonstrative but not limiting.

FIG. 1A is a type A trilaminate roll;

FIG. 1B is a type B bilaminate roll;

FIG. 2 is a type C roll with five laminated layers;

FIG. 3A is a type B bilaminate roll;

FIG. 3B is a type A trilaminate roll;

FIG. 3C is a type C roll with five laminated layers obtained by combining rolls A and B; and

FIG. 4 shows a process diagram of the present invention.

### DETAILED DESCRIPTION OF THE INVENTION

The present invention was developed with the purpose of turning a problem into an opportunity in the trilaminate process to produce a multilaminate of polymers of variable density, by means of a formulated polymeric adhesive.

One of the problems in the automatic multi-laminate process is to avoid manual seams in the process of making hermetic and non-hermetic packages (hermetic bags or not, traditional bag), which represents a non-uniform finish, coupled with the loss of time, Therefore, the present invention of the multilaminate process and adhesive formulation for it is fully automated and the bonding between the polymeric sheets in the reaction of ultra-low-density copolymers and bioriented homopolymers is catalyzed with ultrasound and temperature, this preventing the packages from Hermetic or non-hermetic (bags, hermetic bags) have cracks that do not retain liquids or drain when they are used to contain liquids, they also have a resistance greater than 100 kilograms of force/cm ², flexibility and insulation from external and internal temperatures in their transfer of heat.

Uses:
Waterproof jackets
medical coveralls
lab coveralls
waterproof bags
Bags for personal use
backpacks
Hermetic thermal bags or not
Hermetic resistant bags or not
envelopes for shipping
envelopes for fragile items
tablet holder
computer holder
coolers
lunchboxes
sandwich holder
   The invention is a trilaminate process to make a multilaminate of variable density polymers, using a formulated and laminated polymeric adhesive, that comprises the following process stages:
   I.-Process of elaboration (formation) of ROLL 1 bilayer, two bioriented functions, its descriptions are

### Components:

Component (3): Non-woven fabric. This roll is made with 50% recycled polypropylene monopolymer resin through the agglomerate process.

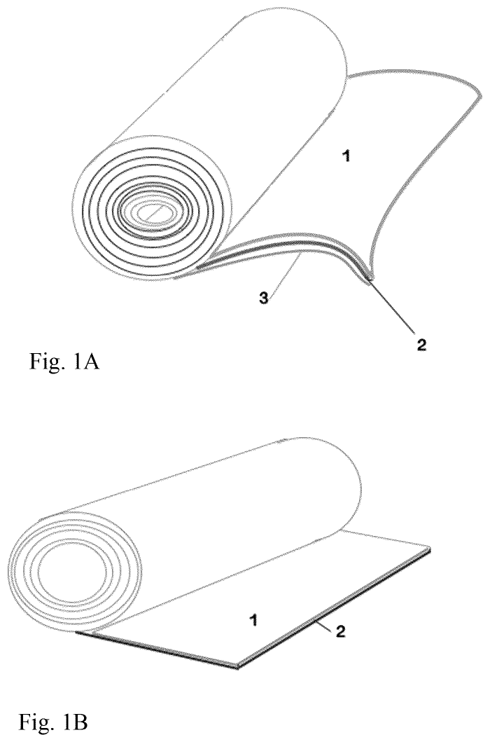

Component (2): its main function is to be a laminated adhesive that is characterized by having combined properties of ultra-low density polyethylene copolymers with low density homopolymers and low fluidity plastomers. That its combination in the formula described here is obtained a laminated product that becomes the base of an adhesive film between the sheets of different polypropylene copolymers, as well as monomers of different densities, which allows lamination in mixed processes of different rough surfaces, smooth and foamy with air bubbles without them being lost in the laminate, as well as metallic laminates. Therefore, the formula of component (2) is described, which comprises:
a. 80-90% low density polyethylene resin used for injection molding, general purpose extrusion coating and lamination can be reduced in density as a coating, is used in high speed processes, provides a good moisture barrier, and is heat sealable at low temperatures.
   Properties: Melt Index D 1238 7.0 g/10 min by ASTM Method, Density D 4883 917 kg/m3 (0.917 g/cm3), DSC Melt Point D 3418 106° C. (223° F.), Vicat Melt Point D 1525 187° F. (86° C.), Maximum Tensile Strength 20 in/min (500 mm/min) D 638 Type IV Sample 1500 psi; Elongation 500 mm/min (20 in/min) D 638 Type IV Sample 400%; Flexural Modulus 1% Secant D 790 30,000 psi. All tests are performed at 73° F. (23° C.) and 50% relative humidity, test method is ASTM. Units are in SI or US Traditional units.
b. 5-10% bare linear low density polyethylene plastomer designed for blown film and extrusion applications, for multilayer films as a core layer to increase dart impact, puncture and tear resistance. Film properties improves flexibility and can be blended with recycled PET to improve physical properties and increase re-incorporation of recycled PET.
   Typical physical properties: Melt index method ASTM D 1238 value at 0.5 g/10 min; Density method ASTM D value in 4883 906 kg/m3 equivalence (0.906 g/cm3); Mist method ASTM D 1003 in percentage of 14.0%; Gloss evaluated at 45° ASTM method D 2457 55, Resistance to Dart Impact method D 1709 value 1750 g; Elmendorf Tear texture resistance device and method by ASTM MD, TD; D 1922, D 1922, 450 g/mil, 750 g/mil; Tensile strength at break ASTM method MD D 882, TD D 882, 55.2 MPa (8000 psi), 44.8 MPa (6500 psi). Elongation at Break method ASTM MD, TD D 882 700%, D 882 950%. Tensile Modulus, ASTM Method 1% Secant ASTM MDTD Method D 882 16,000 psi (110.3 MPa), D 882 14,000 psi (96.5 MPa). All tests are performed at 73° F. (23° C.) and 50% relative humidity.
c. 5-10% low fluidity homopolymer polypropylene with defined mechanical properties and color, excellent thickness control and high resistance in the melt state.
   Melt Flow Index (230° C.-2.16 kg), 1.40 g/10 min, ASTM D-1238 B method; Maximum Tensile Strength (50 mm/min) 4,800 psi or its equivalent 33.1 Mpa, AST method D-638; Elongation at yield point (50 mm/min) 10.0%, ASTM D-638 method; Flexural modulus 1% secant (1.3 mm/min), 210,000 psi, its equivalent 1,447.9 Mpa, ASTM D-790-P method; Slotted Izod Impact (23° C./73° F.) 0.80 ft-lb/in, equivalent 42.7 J/m.
   Process: Component (2) through alkaline solvent lamination can be bi-laminated with the following options: glossy BOPP, matte BOPP, metallic BOPP, these bi-laminations are joined with component (3) which is a non-woven fabric obtained by extrusion until obtaining a fabric by one side at a temperature between 130-140° C. in a travel time of 20 meters per minute and the component (2) that acts as an adhesive on the other side (see FIG. 1) Roll type B to achieve fusion, resistance, elasticity, puncture, among others.
   II.-Process for making ROLL 2 and ROLL 3, characterized by the fact that the foam has air bubbles uniformly and comprises three laminated layers, with two options of polypropylene film, bi-oriented in two BOPP axes or non-woven fabric. In addition, in its process it is characterized by having three fusions at a temperature between 130-140° C. in a travel time of 20 meters per minute, it is described how rolls 2 and 3 are included:
   Component (1): BOPP (Bioriented Polypropylene) has three options:
1.1 Metallic
1.2 Matte
1.3 Bright
   Component (3): Non-woven fabric
   Component (2): It is characterized by its main function as an adhesive
   Component (4): Foam, is characterized by having air bubbles distributed evenly in the roll.
   In this process, two rolls are obtained to combine.

### Process:

(a) Bioriented polypropylene (matte/metallic/glossy) is fused, through alkaline solvent, with component (2) that acts as an adhesive.
(b) Once having the lamination of polyethylene and polypropylene, it is fused at a temperature between 25-40° C. in a travel time of 20 meters per minute, through ultrasound, with the foam until obtaining a single layer of three fused materials, for a bioriented polypropylene side and on the other foam and/or
(c) Non-woven fabric is fused with component (2) through extrusion coating lamination. The component can be seen in FIG. 1A.
(d) The lamination obtained with foam is fused through heat until having a non-woven fabric on one side and foam on the other. See FIG. 1A.
(e) In the combinations of rolls 2 and 3, component (2) remains constant and only the combinations of component (1) vary by 3 (matte, metallic, shiny) and this in turn is combined with the component with the same possibilities. permutations with component (2), resulting in trilaminate rolls, which are characterized by having the property of being processed for multilayer relaminations to the n of at least up to 5 layers, where n is equal to an infinite number of layers in millimeters of thickness.
   III.-Production process of ROLL 4 and ROLL 5, They are characterized because they have thermal properties of two thermo rolls (roll 2, roll 3) and 5 multilayer fusions with two options, BOPP or non-woven fabric, at a temperature between 25-40° C. and alkaline solvent and at a travel time of 20 meters per minute and with 50% relative humidity RH.

### Components: 5 Fusions

Component (1): BOPP (Bioriented Polypropylene) has three options
a. Metallic
b. Matte
c. Bright
   Combined with the three possibilities component (1) and Component (3) Non-woven fabric
   Component (2): It is characterized by its main function as an adhesive
   Component (4): Espumin is characterized by its homogeneous air bubbles and comprises three laminated layers, with two options of polypropylene film, bioriented in two BOPP axes, forming rolls 4 and roll 5.
   Component (2): It is characterized by its main function as an adhesive
   Component 1: BOPP (Bioriented Polypropylene) has three options

### Process:

(a) Bioriented polypropylene (matte/metallized/glossy) is fused, through alkaline solvent, with component (2) that is characterized as an adhesive.
   Once the lamination of ultra-low density polyethylene homopolymers and polypropylene copolymers is obtained, it is fused, through ultrasound that generates a homogeneous controlled temperature of 25-140° C. and alkaline solvent in a travel time of 20 meters per minute with 50% of relative humidity HR (environment in process), has a temperature gradient for each added layer in the multilaminate is 2-5° C. for each layer up to the range 25-140° C.
(b) It is joined to step 3.1 with the foam until obtaining a single layer of three fused materials, on one side bioriented polypropylene and on the other foam.
(c) Next, the previous lamination is fused, through heat at 130° C.-140° C., increasing 1-5 10° C. for each layer that is added to the system, in a travel time of 20 meters per minute and with a humidity of 50% relative humidity HR (process environment) with the lamination of 100-gauge polyethylene film with bioriented polypropylene until five lamination layers are obtained (bioriented polypropylene component (1), component (2), Foam component (4), component (2), bioriented polypropylene component (4)).

Non-woven fabric is fused with adhesive component (2) through extrusion coating lamination.

The lamination obtained with Roll 2 foam is fused through heat at 130-140° C. in a travel time of 20 meters per minute and with a humidity of 50% relative humidity HR (process environment), until having on one side non-woven fabric. woven and on the other foam.

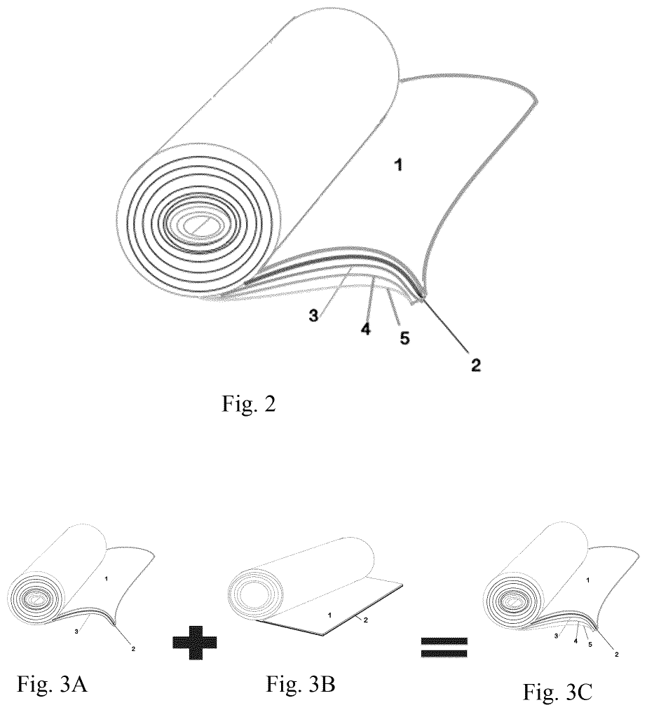

Next, the previous lamination is fused, through heat at 130-140° C. with a change gradient of 2-5° C. for each layer added in a travel time of 20 meters per minute and with a humidity of 50% relative humidity HR (process environment), with the lamination of 100 caliber (mm) polyethylene film with bioriented polypropylene until five lamination layers are obtained (bioriented polypropylene Component (1), Component (2) adhesive, foam component (4), Component (2) adhesive, bioriented polypropylene component (1)). FIG. 2 shows the minimum combination in rolls A+B=C, where roll A (roll 2 or roll 3) has its aforementioned combinations, roll B (roll 1) is a basic two-layer roll and roll C (roll 4 or roll 5) is the result of at least 5 layers and these can be added n times according to the number of layers that are required, maintaining their homogeneous fusions. n is equal to an infinite number of layers in millimeters of thickness, but changing their properties according to the required need, for example if greater resistance, flexibility, resistance to internal or external heat transfer, permeability to oxygen, gases, liquids or simply greater resistance to shear or tensile forces of at least 100 KgF/cm², etc., are required. The material is GRAS (generally recognized as safe), used by federal regulatory agencies to refer to for substances that are used as food additives, but that are generally recognized as safe when used according to good manufacturing practices. The required combinations are made, for example A+B=C, C+A=D, C+B=F, C+D+F=G, where these roll relationships can give us n combinations and vary their densities, n is equal to an infinite number of combinations and finally this process occurs in an automatic multi-laminate machine.

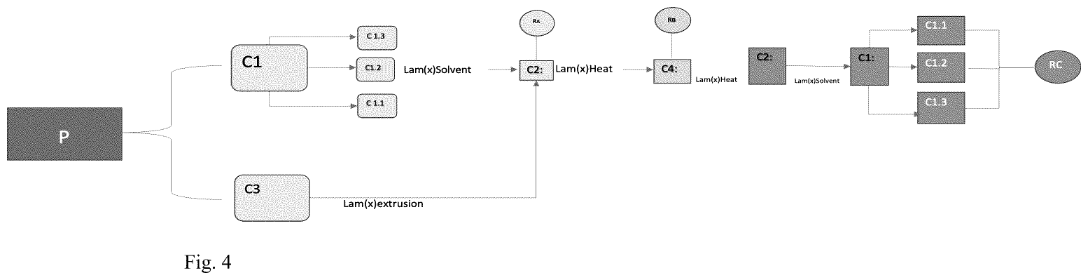

FIG. 4 shows a process diagram of the present invention. In FIG. 4, P=a multilaminate product of the invention; C1=BOPP which can be flat and fluffy (air bubbles), C3=Non-woven fabric, C1.1=metallic material (BOPP), C1.2=matte material (BOPP), C1.3=glossy material (BOPP), C2=component (2), R1=roll 1 multilaminate product of the invention, C4=foam, R2=roll 2 multilaminate product of the invention, PT=a thermal multilaminate product invention, R3=roll 3 multilaminate product of the invention, in which BOPP is bioriented polypropylene.

1.-9. (canceled)

10. A process for making a multilaminate comprising polymers of variable density, the method comprising:
a. making a bilayer roll 1 comprising laminating a layer comprising a component (2) and a layer comprising a component (3), wherein the component (2) is a polymer adhesive and the component (3) is a non-woven fabric comprising at least 50% recycled polypropylene resin;
b. making a trilayer roll 2 containing three laminated layers, comprising laminating a layer comprising a component (1) and a bilayer from the roll 1, wherein component (1) comprises a bioriented polypropylene;
c. making a trilayer roll 3 containing three laminated layers, comprising laminating a layer comprising a component (4) and a bilayer from the roll 1, wherein component (4) comprises a polyethylene foam having uniformly distributed air bubbles; and
d. making a multilayer roll 4 and a multilayer roll 5, wherein each of roll 4 and roll 5 contains at least two selected from the group consisting of a bilayer from roll 1, a trilayer from roll 2, and a trilayer from roll 3.

11. The process according to claim 10, wherein component (2) comprises 80-90% low-density polyethylene resin, 5-10% bare linear low density polyethylene plastomer, and 5-10% low fluidity homopolymer polypropylene.

12. The process according to claim 11, wherein component (2) further comprises at least one of a glossy bioriented polypropylene, a matte bioriented polypropylene, and a metallic bioriented polypropylene.

13. The process according to claim 10, wherein component (1) comprises a glossy bioriented polypropylene, a matte bioriented polypropylene, or a metallic bioriented polypropylene.

14. The process according to claim 10, wherein the step of making the roll 1 comprises fusing the layers at 130° C. to 140° C. at a rate of 20 meters per minute.

15. The process according to claim 10, wherein the step of making the roll 2 comprises fusing the layers at 130° C. to 140° C. at a rate of 20 meters per minute.

16. The process according to claim 10, wherein the step of making the roll 3 comprises fusing the layers at 15° C. to 40° C. at a rate of 20 meters per minute.

17. The process according to claim 10, wherein at least one of roll 4 and roll 5 is obtained with an alkaline solvent.

18. The process according to claim 10, wherein step d comprises sequentially adding layers at a fusion temperature which increases by 2° C. to 5° C. to a maximum of 25° C. to 140° C.

19. The process according to claim 10, wherein the multilaminate contains at least five layers.

20. The process according to claim 10, wherein the multilaminate comprises at least three selected from the group consisting of a layer from roll 1, a layer from roll 2, a layer from roll 3, a layer from roll 4, and a layer from roll 5.

21. The process according to claim 10, wherein the multilaminate is GRAS (generally recognized as safe).
